(19) United States
(12) Patent Application Publication
(10) Pub. No.: US 2011/0209594 A1
(43) Pub. Date: Sep. 1, 2011

(54) Dispenser For A Roll Of Sheet Material

(76) Inventor: Philip Craig Withers, Victoria (AU)

(21) Appl. No.: 12/934,109

(22) PCT Filed: Mar. 31, 2009
(86) PCT No.: PCT/AU09/00387

§ 371 Date: May 3, 2011

(30) Foreign Application Priority Data
Mar. 31, 2008 (AU) 2008901534
Aug. 15, 2008 (AU) 2008904226

(51) Int. Cl. B65H 75/32; B26D 1/04; B26D 7/01

(52) U.S. Cl. 83/614; 83/578; 83/649

(57) ABSTRACT

A box adapted to slidably mount a cutter directly to the box without an intervening sliding track assembly mounted to the box.

### FIELD OF THE INVENTION

The present invention relates to a dispenser for a roll of sheet material.

### BACKGROUND OF THE INVENTION

Sheet material, such as plastic film or cling wrap, is conventionally sold on a roll contained in a dispenser consisting of a box with a cutter that is slidable along an intervening sliding track (or rail) assembly mounted on the box. The sliding track assembly is conventionally a separate component that must be mounted on the box during manufacture, or before use, of the dispenser. The separate sliding track assembly increases the cost and complexity of conventional dispensers. Furthermore, the sliding track assembly can become detached from the box and lost.

What is needed is a dispenser for a roll of sheet material which addresses the above difficulties.

### SUMMARY OF THE INVENTION

According to the present invention, there is provided a box adapted to slidably mount a cutter directly to the box without an intervening sliding track assembly mounted to the box.

The box can have two or more integrally-formed surfaces and/or edges adapted to slidably mount the cutter directly to the box.

The two or more integrally-formed surfaces and/or edges can be a chamfered longitudinal corner of two longitudinal walls, wherein the cutter is slidably mountable directly on the chamfered longitudinal corner between converging continuations of the two longitudinal walls that define an angled slot.

The angled slot can be a truncated triangle in transverse cross section. The truncated triangle can be a truncated equilateral triangle.

The box can have internal transverse bracing to maintain the box shape and/or the transverse cross section shape of the angled slot.

The box can have two longitudinally-spaced transverse end walls with respective corners that respectively overlie opposed ends of the angled slot to act as end-stops for the cutter.

The transverse end walls can have respective inwardly foldable cut-outs to rotatably support a roll of sheet material longitudinally contained in the box.

The box can have a longitudinal aperture parallel to the angled slot for dispensing sheet material off the roll, out of the box, and over the angled slot for cutting by the cutter.

The box can also have a longitudinal lid hingedly moveable to selectively cover the longitudinal aperture.

The longitudinal lid can have longitudinally-spaced end portions that are respectively latchable to the respective transverse end walls.

The angled slot can have a longitudinal edge with a finger cut-out therein for enabling a user to grip sheet material adjacent to the angled slot.

The box can have a tear-off corner cover to longitudinally cover the angled slot.

The box can have a rectangular transverse cross section before the corner cover is torn off.

The box can also have an attractant strip on one or both sides of the angled slot for attracting sheet material thereto for cutting by the cutter. The attractant strip can be a coating of an attractant material or an adhered length of an attractant tape.

The box can be constructed from a cut and scored blank of foldable rigid or semi-rigid material.

The present invention also provides a cutter adapted to be slidably mounted directly to a box without an intervening sliding track assembly mounted to the box.

The cutter can have two opposite-facing cutting edges longitudinally mounted between a head and a base both of which have longitudinal side surfaces that converge in transverse cross section towards the head.

The two opposite-facing cutting edges can be respectively vertically inclined at an angle between 0° and 90° sufficient to prevent or minimise bunching or crinkling of sheet material during cutting thereof by the cutter. The angle can be between 20° and 60°. The angle can be 40°.

The base can have two laterally-spaced and/or longitudinally-spaced skids yieldably biased downwardly from the head.

The head can rotatably carry two longitudinally-spaced and laterally-offset serrated wheels above the base and respectively ahead of the two cutting edges.

The present invention further provides a dispenser for a roll of sheet material including the above box and the above cutter.

### BRIEF DESCRIPTION OF THE DRAWINGS

The invention will be further described by way of example only with reference to the accompanying drawings, in which:

FIG. 1 is a perspective view of an embodiment of a dispenser for a roll of sheet material of the present invention;

FIG. 2 is a transverse cross section through the dispenser;

FIG. 3 is a partial perspective view of the dispenser with a tear-off corner cover;

FIG. 4 is a partial perspective view of the dispenser with the tear-off corner cover removed to reveal a finger cut-out for gripping sheet material;

FIGS. 5 to 22 illustrate construction of the dispenser from a box blank;

FIG. 23 is a perspective view of an embodiment of a cutter of the dispenser;

FIG. 24 is a side view of the cutter; and

FIG. 25 is a perspective view of an embodiment of the cutter with serrated wheels.

### DETAILED DESCRIPTION

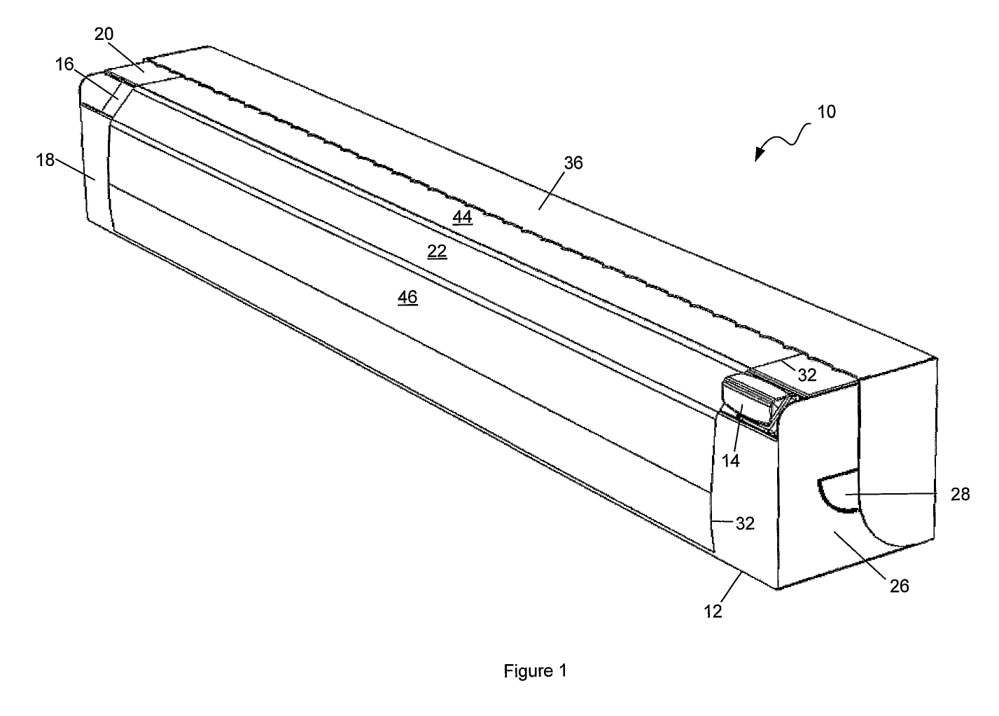

An embodiment of a dispenser 10 of the invention is illustrated in FIG. 1. The dispenser 10 has a box 12 adapted to slidably mount a cutter 14 directly to the box 12 without an intervening sliding track assembly (not shown) mounted to the box 12. The box 12 is, for example, a hollow longitudinal box with two or more integrally-formed surfaces and/or edges adapted to slidably mount the cutter 14 directly to the box 12. The two or more integrally-formed surfaces and/or edges of the box 12 are, for example, a chamfered longitudinal corner 16 of two longitudinal walls 18, 20, for example, a front wall 18 and a top wall 20. The cutter 14 is slidably mounted directly on the chamfered longitudinal corner 16 between converging continuations of the front and top walls 18, 20 which act as two mutually inwardly-inclined flanges that define an angled slot 22.

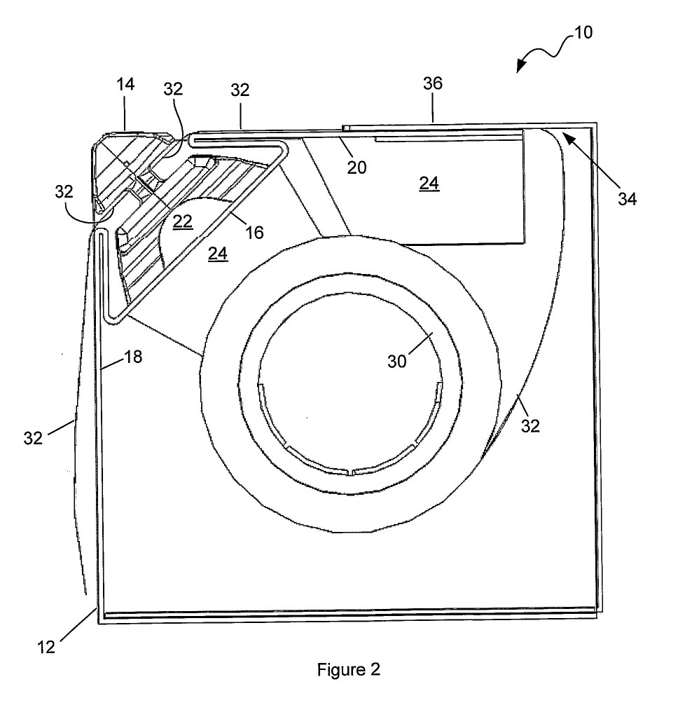

Referring to FIG. 2, the angled slot 22 is a truncated triangle, for example a truncated equilateral triangle, in transverse cross section. The angled slot 22 is formed from double-layered folded continuations of the front and top walls 18, 20 which form two mutually inwardly-inclined flanges, while the chamfered longitudinal corner 16 is a single-layered continuation of them. The box 12 has internal transverse bracing 24 to maintain the shape of the box 12 and/or the transverse cross section shape of the angled slot 22.

Referring again to FIG. 1, the box has two longitudinally-spaced transverse end walls 26 with respective corners that respectively overlie opposed ends of the angled slot 22 to act as end-stops for the cutter 14. The transverse end walls 24 have respective inwardly foldable cut-outs 28 to rotatably support a roll 30 of sheet material 32, for example plastic film or cling wrap, longitudinally contained in the box 12, as illustrated in FIG. 2. The internal transverse bracing 24 is shaped so as not to interfere with rotation of the roll 30.

Referring to FIG. 2, the box 12 also has a longitudinal aperture 34 parallel to the angled slot 22 for dispensing sheet material 32 off the roll 30, out of the box 12, and over the angled slot 22 for cutting by the cutter 14. The box 12 also has a longitudinal lid 36 which is longitudinally hinged from a bottom, rear longitudinal corner of the box 12 so as to be hingedly moveable to selectively cover the longitudinal aperture 34. Referring again to FIG. 1, the longitudinal lid 36 has longitudinally-spaced end portions that are respectively latchable to the respective transverse end walls 26. The longitudinally-spaced end portions of the longitudinal lid 36 and the transverse end walls 26 can respectively have co-operable latch tabs (not shown) thereon.

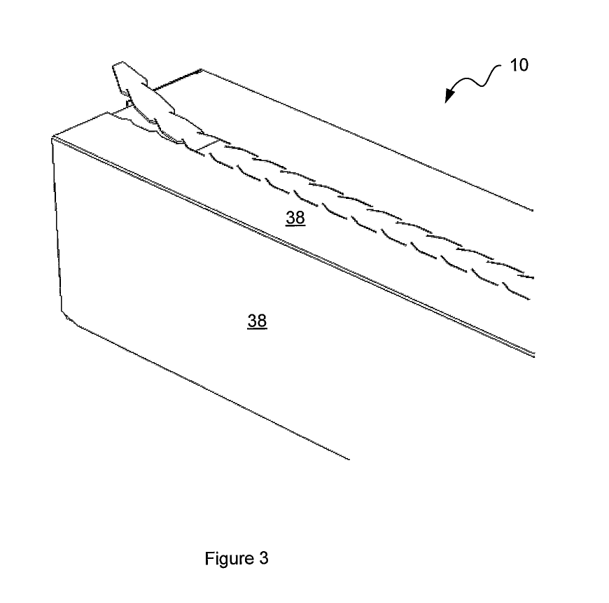

Referring to FIG. 3, the box 12 has a tear-off corner cover 38 to longitudinally cover the angled slot 22, and to give the box 12 a rectangular transverse cross section before the corner cover 38 is torn off.

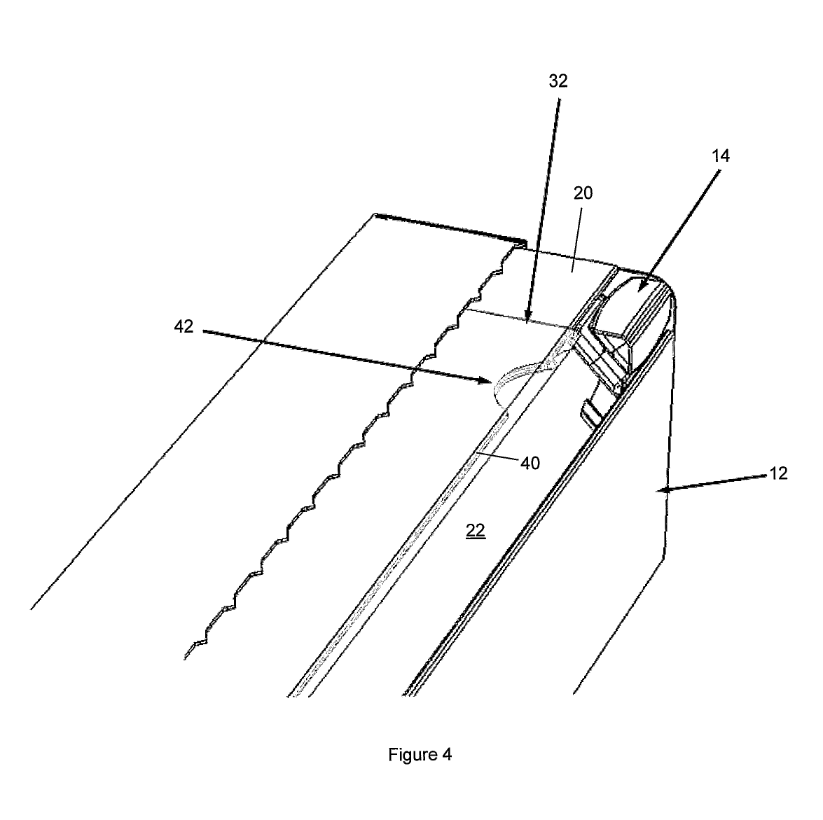

Referring to FIG. 4, the angled slot 22 has a longitudinal edge 40 with a finger cut-out 42, for example a semi-circular cut-out, therein for enabling a user to grip sheet material 32 overlying the top wall 20 adjacent to the angled slot 22.

Referring again to FIG. 1, the box has attractant strips 44, 46 on both sides of the angled slot 22 for attracting sheet material 32 thereto for cutting by the cutter 14. The attractant strips 44, 46 are, for example, a coating of an attractant plastic material, or an adhered length of an attractant plastic tape. The attractant strips 44, 46 enable sheet material 32 to be tensioned across the angled slot 22 to thereby prevent or minimise bunching or crinkling of sheet material 32 during cutting thereof by the cutter 14.

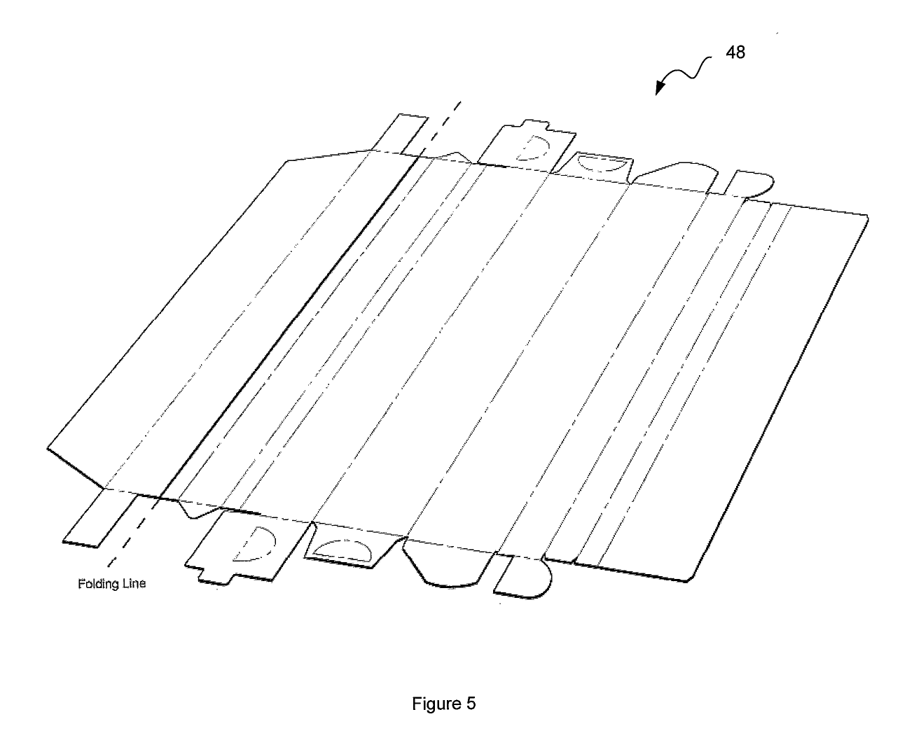

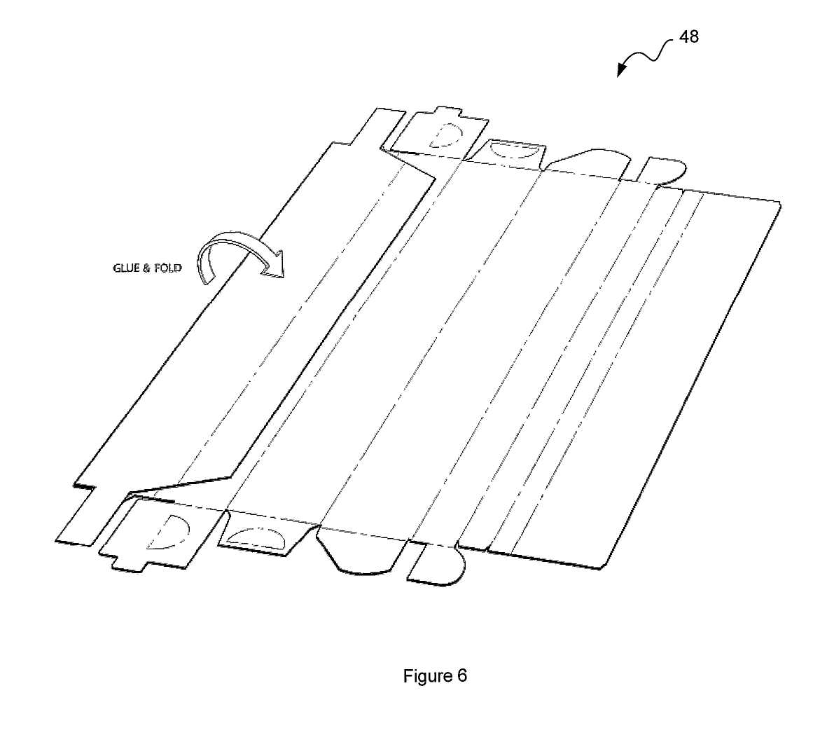

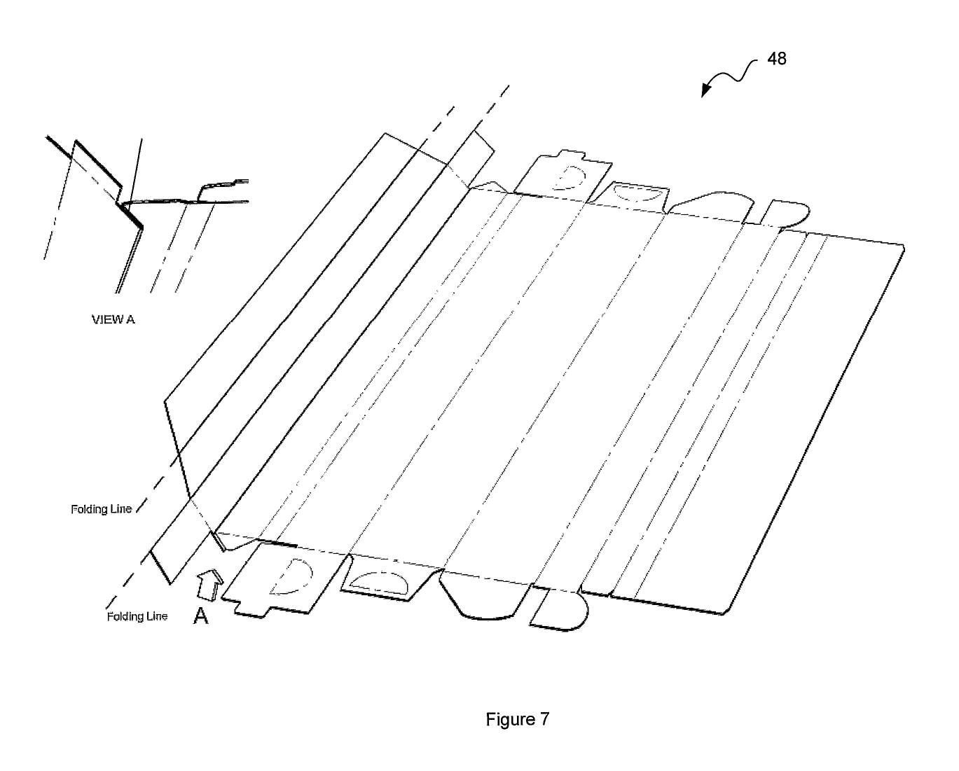

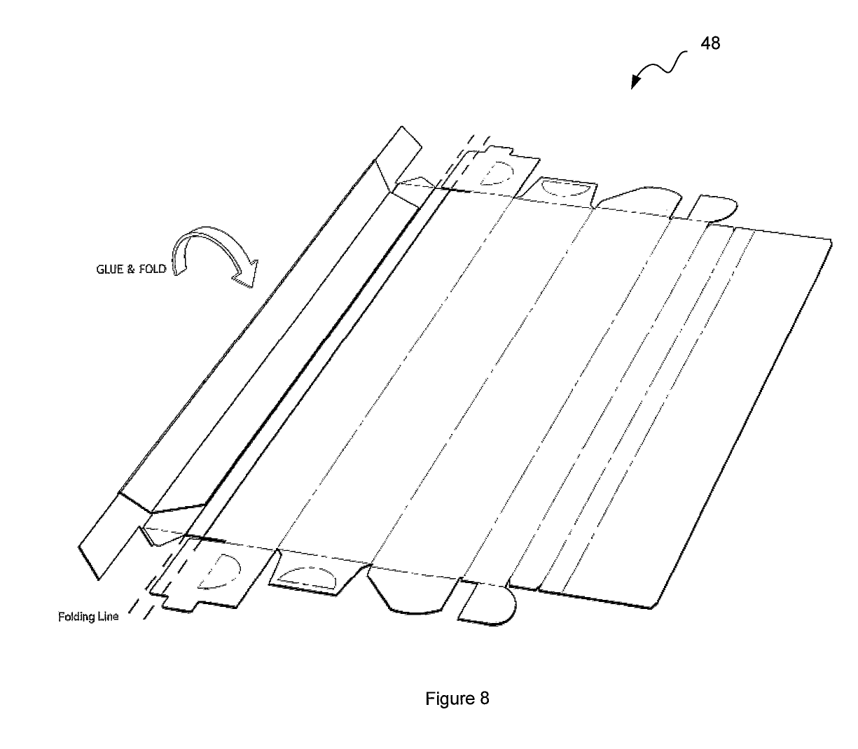

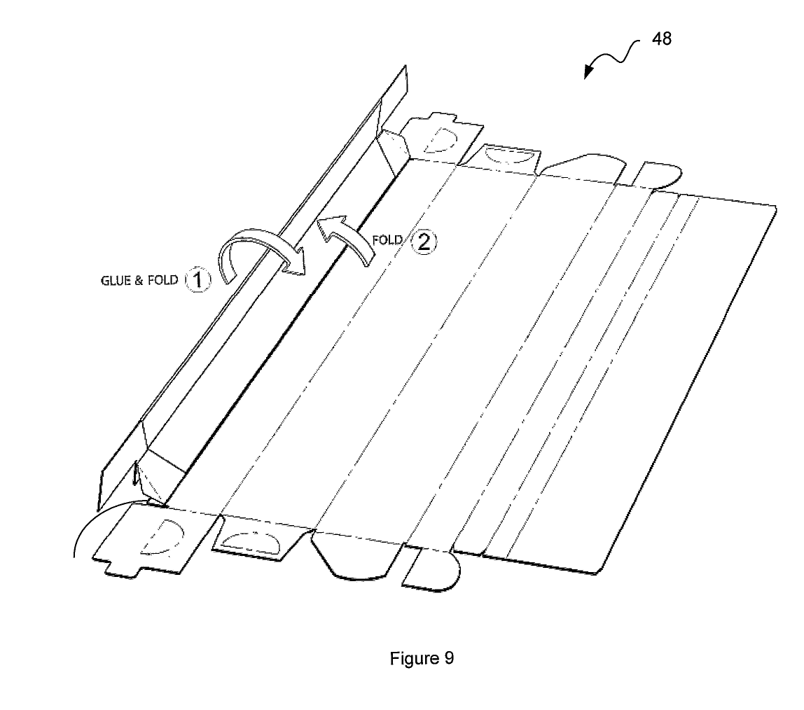

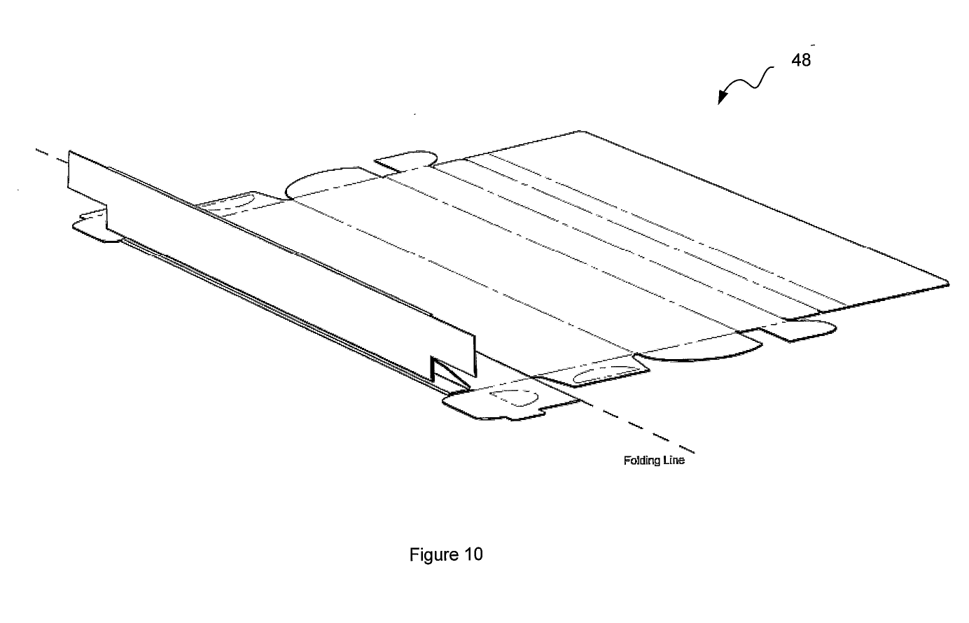

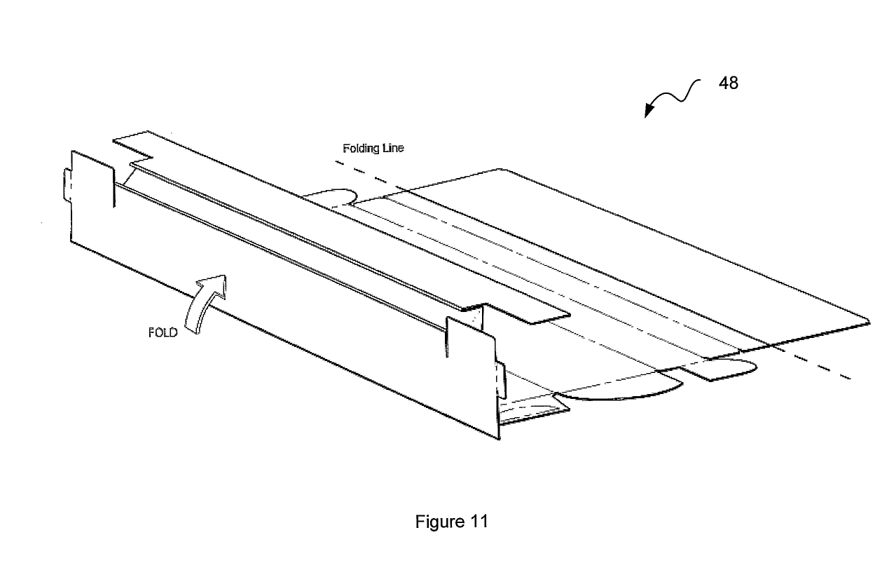

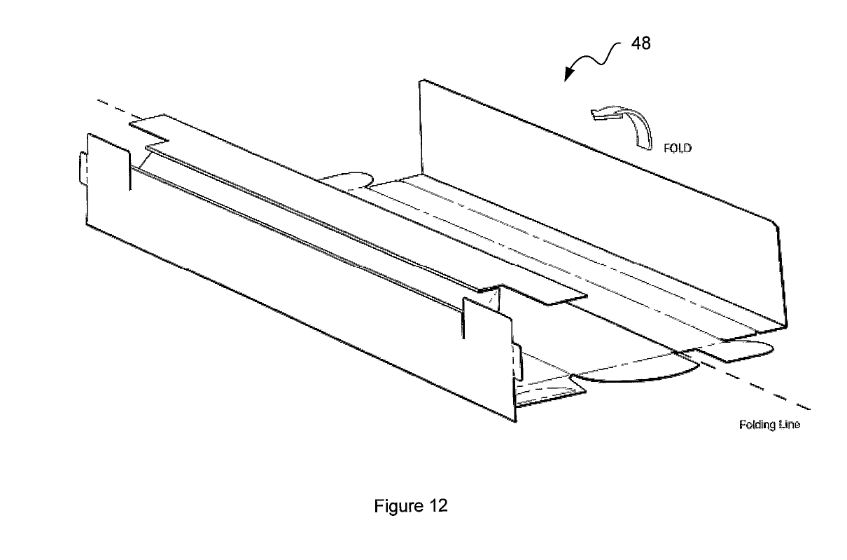

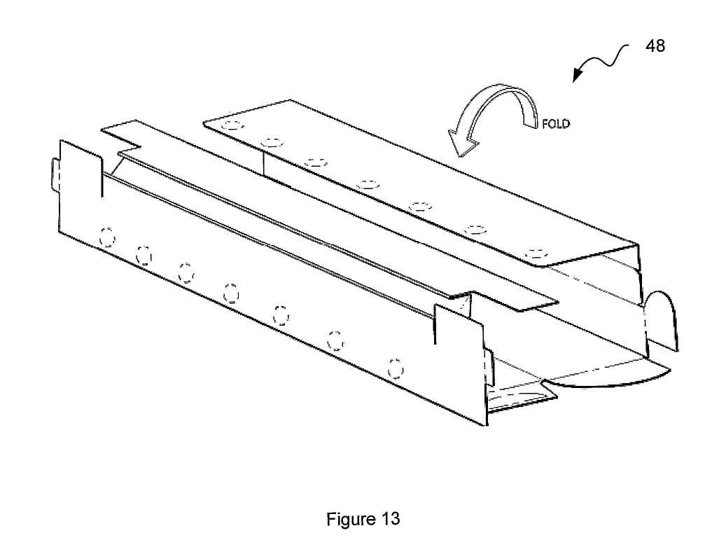

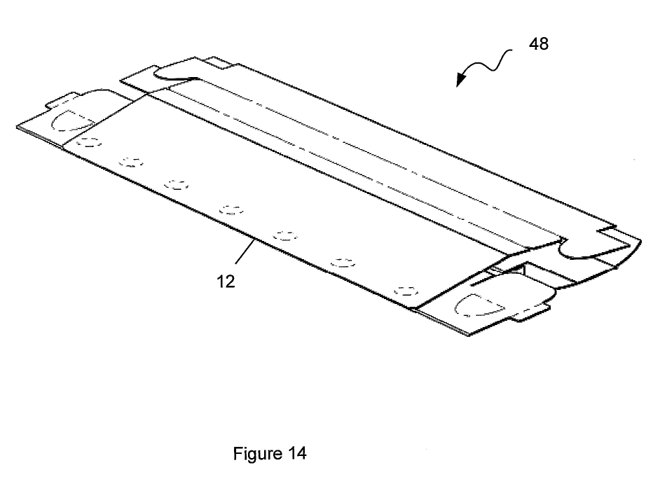

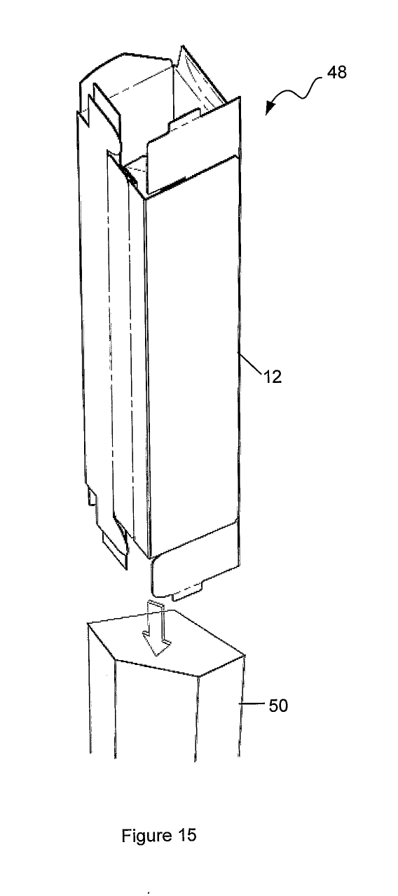

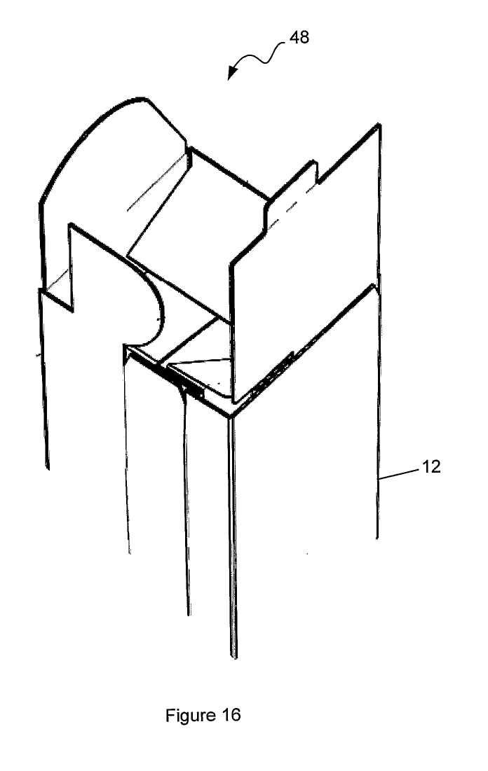

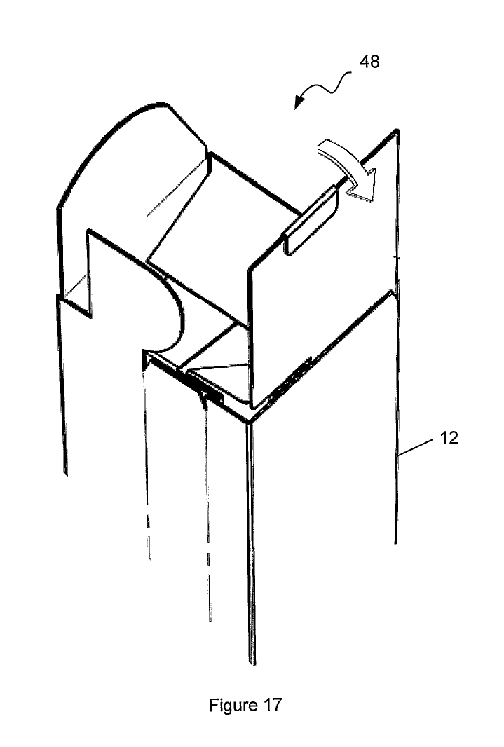

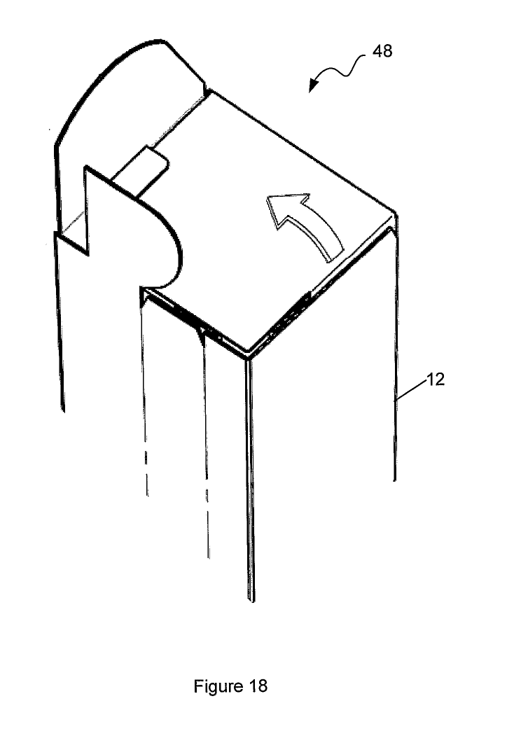

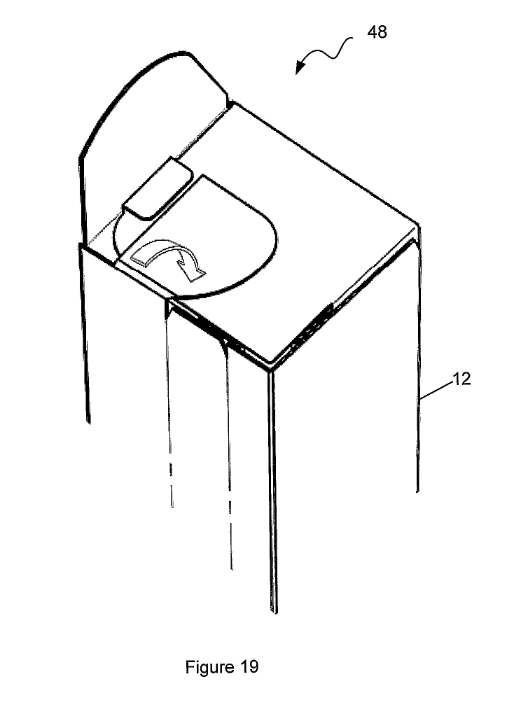

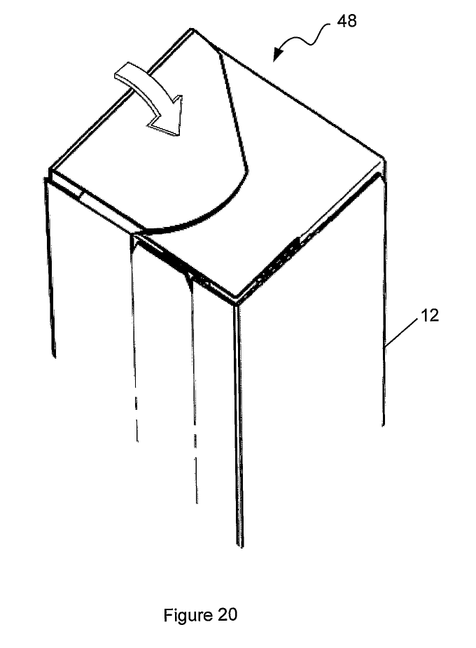

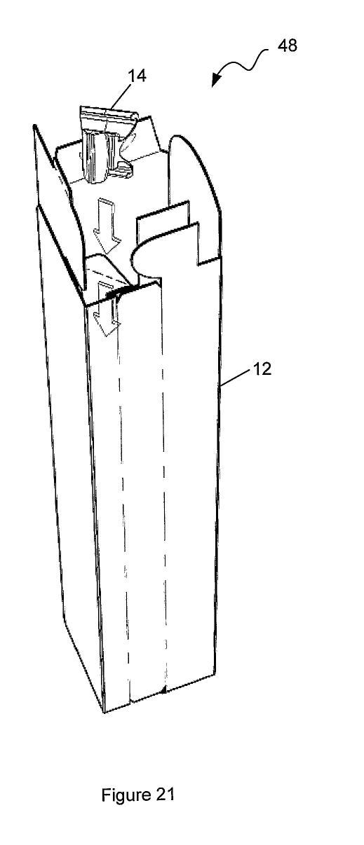

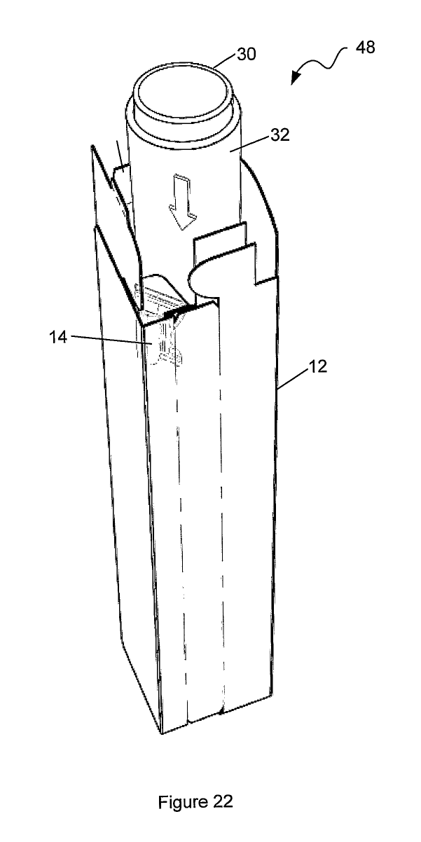

The box 12 is, for example, constructed from a cut and scored blank 48 of foldable rigid or semi-rigid material, for example, cardboard or paperboard. FIGS. 5 to 14 illustrate sequential folding and gluing (illustrated by shaded areas) of main sections of an example blank 48 to form a partially constructed box 12. FIG. 15 illustrates shaping the partially constructed box 12 on a shape former 50 to give the box 12 a rectangular transverse cross section, and to give the angled slot 22 a truncated triangular transverse cross section. FIGS. 16 to 20 illustrate sequential folding and gluing of end flaps of the example blank 48 to close one end of the angled slot 22 and the box 12. FIGS. 21 and 22 respectively illustrate insertion of the cutter 14 and the roll 30 of sheet material 32 into the remaining open end of the angled slot 22 and the box 12 which is then closed by repeating the folding and gluing of end flaps illustrated in FIGS. 16 to 20.

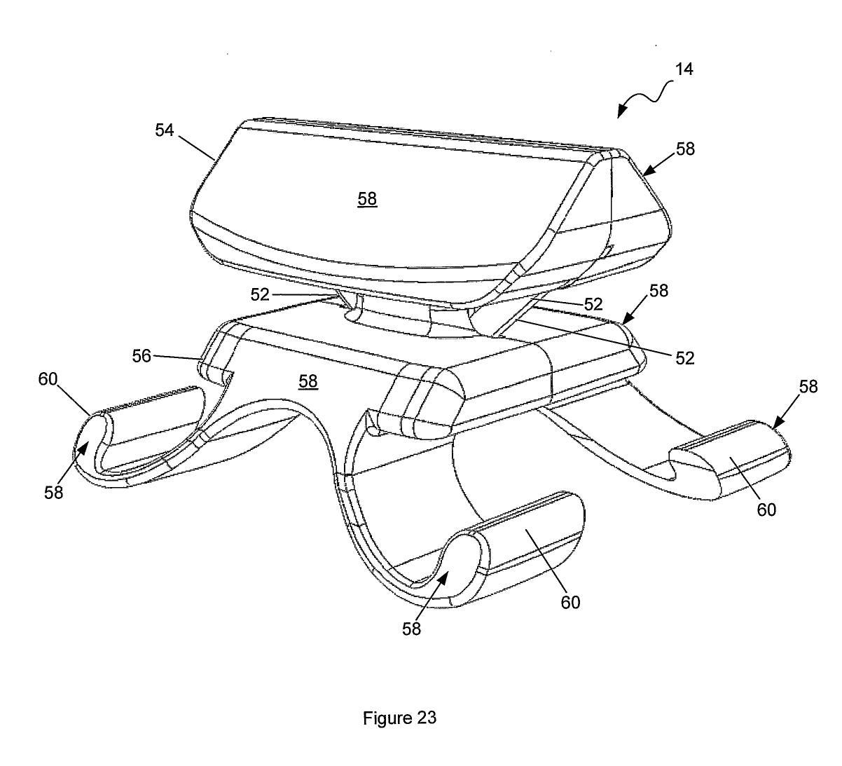

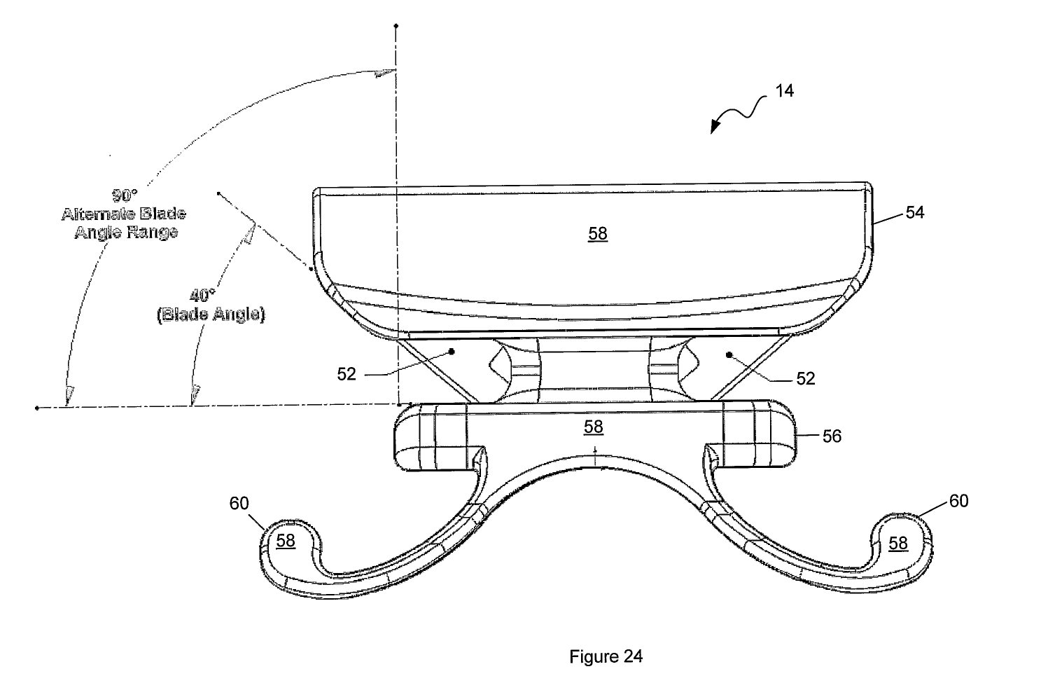

An embodiment of the cutter 14 is illustrated in FIGS. 23 and 24. The cutter 14 is adapted to be slidably mounted directly to the box 12 without an intervening sliding track assembly mounted to the box 12. The cutter 14 has two opposite-facing cutting edges 52 longitudinally mounted between a head 54 and a base 56 both of which have longitudinal side surfaces 58 that converge in transverse cross section towards the head 54. The base 56 can have two laterally-spaced skids 60 yieldably biased downwardly from the head 54.

The downwards yieldable biasing of the skids 60 assists to maintain the cutter 14 in sliding engagement with the internal surfaces of the angled slot 22. The cutter 14 is formed, for example, as a moulding in plastics. The cutting edges 52 are formed, for example, of metal blades with razor-blade sharpness.

Referring to FIG. 24, the two opposite-facing cutting edges 52 are respectively vertically inclined at an angle between 0° and 90° sufficient to prevent or minimise bunching or crinkling of sheet material 32 during cutting thereof by the cutter 14. The angle is, for example, between 20° and 60°, for example, 40°.

The cutter 14 and its longitudinal side surfaces 58 are sized and shaped relative to abutting internal side surfaces of the angled slot 22 to have tight tolerances so as to exert a small outward or opening force against the internal side surfaces of the angled slot 22 which is sufficient to spread the converging flanges of the angled slot 22 apart, and thereby pre-tension sheet material 32 ahead of the cutter 14. The close tolerance between abutting side surfaces of the cutter 14 and the angled slot 22 slightly biases the angled slot 22 open when the cutter 14 is slid along the angled slot 22 to thereby assist in tensioning sheet material 32 to prevent or minimise bunching or crinkling of sheet material 32 during cutting thereof by the cutter 14.

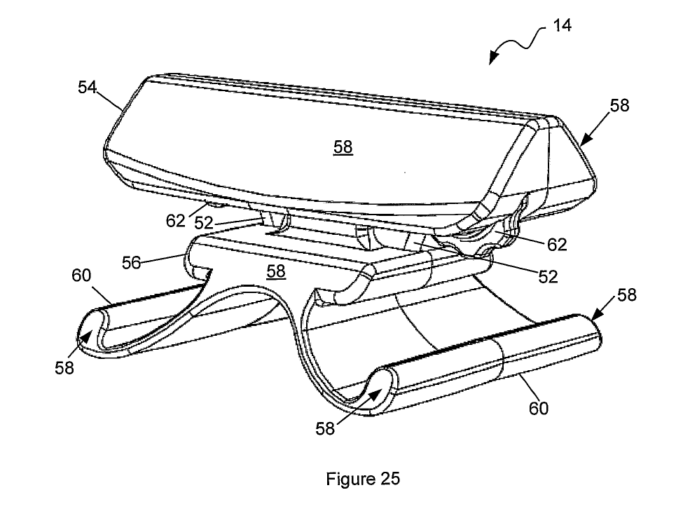

FIG. 25 illustrates another embodiment of the cutter 14 in which the head 54 rotatably carries two longitudinally-spaced and laterally-offset serrated wheels 62 above the base 56 and respectively ahead of the two cutting edges 52. The serrated wheels 62 engage sheet material 32 ahead of the cutting edges 52 to pre-tension sheet material 32 ahead of the cutter 14, and thereby assist in preventing or minimising bunching or crinkling of sheet material 32 during cutting thereof by the cutter 14.

The embodiments have been described by way of example only and modifications are possible within the scope of the claims which follow.

1. A box adapted to slidably mount a cutter directly to the box without an intervening sliding track assembly mounted to the box.

2. A box according to claim 1, wherein the box has two or more integrally-formed surfaces and/or edges adapted to slidably mount the cutter directly to the box.

3. A box according to claim 2, wherein the two or more integrally-formed surfaces and/or edges are a chamfered longitudinal corner of two longitudinal walls, wherein the cutter is slidably mountable directly on the chamfered longitudinal corner between converging continuations of the two longitudinal walls that define an angled slot.

4. A box according to claim 3, wherein the angled slot is a truncated triangle in transverse cross section.

5. A box according to claim 4, wherein the truncated triangle is a truncated equilateral triangle.

6. A box according to claim 4 or 5, wherein the box has internal transverse bracing to maintain the box shape and/or the transverse cross section shape of the angled slot.

7. A box according to any one of claims 3 to 6, wherein the box has two longitudinally-spaced transverse end walls with respective corners that respectively overlie opposed ends of the angled slot to act as end-stops for the cutter.

8. A box according to claim 7, wherein the transverse end walls have respective inwardly foldable cut-outs to rotatably support a roll of sheet material longitudinally contained in the box.

9. A box according to claim 8, wherein the box has a longitudinal aperture parallel to the angled slot for dispensing sheet material off the roll, out of the box, and over the angled slot for cutting by the cutter.

10. A box according to claim 9, wherein the box has a longitudinal lid hingedly moveable to selectively cover the longitudinal aperture.

11. A box according to claim 10, wherein the longitudinal lid has longitudinally-spaced end portions that are respectively latchable to the respective transverse end walls.

12. A box according to any one of claims 3 to 11, wherein the angled slot has a longitudinal edge with a finger cut-out therein for enabling a user to grip sheet material adjacent to the angled slot.

13. A box according to any one of claims 3 to 12, wherein the box has a tear-off corner cover to longitudinally cover the angled slot.

14. A box according to claim 13, wherein the box has a rectangular transverse cross section before the corner cover is torn off.

15. A box according to any one of claims 3 to 14, wherein the box has an attractant strip on one or both sides of the angled slot for attracting sheet material thereto for cutting by the cutter.

16. A box according to claim 15, wherein the attractant strip is a coating of an attractant material or an adhered length of an attractant tape.

17. A box according to any preceding claim, wherein the box is constructed from a cut and scored blank of foldable rigid or semi-rigid material.

18. A cutter adapted to be slidably mounted directly to a box without an intervening sliding track assembly mounted to the box.

19. A cutter according to claim 18, wherein the cutter has two opposite-facing cutting edges longitudinally mounted between a head and a base both of which have longitudinal side surfaces that converge in transverse cross section towards the head.

20. A cutter according to claim 19, wherein the two opposite-facing cutting edges are respectively vertically inclined at an angle between 0° and 90° sufficient to prevent or minimise bunching or crinkling of sheet material during cutting thereof by the cutter.

21. A cutter according to claim 20, wherein the angle is between 20° and 60°.

22. A cutter according to claim 21, wherein the angle is 40°.

23. A cutter according to any one of claims 18 to 22, wherein the base has two laterally-spaced and/or longitudinally-spaced skids yieldably biased downwardly from the head.

24. A cutter according to any one of claims 18 to 23, wherein the head rotatably carries two longitudinally-spaced and laterally-offset serrated wheels above the base and respectively ahead of the two cutting edges.

25. A dispenser for a roll of sheet material including a box according to any one of claims 1 to 17, and a cutter according to any one of claims 18 to 24.
